(19) United States
(12) Patent Application Publication
(10) Pub. No.: US 2009/0092392 A1
(43) Pub. Date: Apr. 9, 2009

(54) VIRTUAL I/Q MULTIPLEXING IN OPTICAL CODE DIVISION FOR SECURE LOCAL AREA OFDM

(75) Inventors: Yue-Kai Huang, Princeton, NJ (US); Ting Wang, Princeton, NJ (US); Junqiang Hu, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/181,656

(22) Filed: Jul. 29, 2008

Related U.S. Application Data
(60) Provisional application No. 60/978,282, filed on Oct. 8, 2007.

(51) Int. Cl. H04J 14/00

(52) U.S. Cl. 398/79

(57) ABSTRACT

A system and method for virtual I/Q multiplexing in optical code division for secure local area OFDM includes encoding a wide spectrum signal, which includes a plurality of spectral bins, to provide a complementary spectral coding over at least two channels. The complementary spectral codings are intensity modulated with opposite polarity for each channel. An M-ary Orthogonal Frequency Division Multiplexing (OFDM) signal is modulated using the complementary spectral codings of opposite polarity with separate complementary spectral encoded (CSE) optical codes to provide a virtual in-phase (I) and quadrature (Q) (I/Q) multiplexing for the OFDM signal.

### RELATED APPLICATION INFORMATION

This application claims priority to provisional application Ser. No. 60/978,282 filed on Oct. 8, 2007, incorporated herein by reference.

### BACKGROUND

1. Technical Field

The present invention relates to secure optical signal transmission, and more particularly to a system and method for virtual I/Q multiplexing in optical code division.

2. Description of the Related Art

Orthogonal frequency division multiplexing (OFDM) has been widely adopted in wireless communication. OFDM dominates in wireless broadcast systems such as Wireless Fidelity (WiFi), and Worldwide Interoperability for Microwave Access (WiMAX) because of its robustness to multi-path fading and high sub-carrier density through digital Fast Fourier Transforms (FFT) and Inverse Fast Fourier Transforms (IFFT). As the underlying optical backbone networks, such as a passive optical networks (PON), become extensively deployed, cost-effective implementation of high-speed PON to provide scalable and secure access of radio over fiber (ROF) is of great interest.

OFDM can provide better spectrum utilization and increased transmission rate using low-cost optical components by M-ary modulation on its sub-carriers, such as phase-shifted-keying (PSK) or quadrature amplitude modulation (QAM). Traditionally, these carrier phase modulation schemes needed phase sensitive systems, such as coherent optical detection, which usually have strict requirements on the phase noise of the laser source and two-stage down conversion by local oscillators. The technology used in the coherent optical approach for M-ary OFDM signals still needs to mature for commercial application due to its complexity and high-cost.

Optical Code Division Multiple Access (OCDMA) has recently attracted wide attention due to its ability to grant robust and asynchronous access to multiple communication channels with scalability and physical security. Binary PSK (BPSK) and Quadrature PSK (QPSK) transmission had been implemented by using optical codes to represent each value within the transmitted symbol. However, these methods can only support digital data transmission and cannot be applied to the analog waveforms of OFDM signals. Also, these methods have scalability issues when the alphabet of the M-ary system becomes larger (e.g., 16-QAM), since every alphabet will need one optical code. A spectral encoded OCDMA system has been shown to support analog signal waveforms for ROF applications.

### SUMMARY

A system and method for virtual I/Q multiplexing in optical code division for secure local area OFDM includes encoding a wide spectrum signal, which includes a plurality of spectral bins, to provide a complementary spectral coding over at least two channels. The complementary spectral codings are intensity modulated with opposite polarity for each channel. An M-ary Orthogonal Frequency Division Multiplexing (OFDM) signal is modulated using the complementary spectral codings of opposite polarity with separate complementary spectral encoded (CSE) optical codes to provide a virtual in-phase (I) and quadrature (Q) (I/Q) multiplexing for the OFDM signal.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a transmitter and a receiver for complementary spectral encoding and decoding in accordance with one illustrative embodiment;

FIG. 2 is an I/Q diagram illustratively showing optical codes in accordance with one illustrative embodiment;

FIG. 3 is a block/flow diagram showing a transmission method in accordance with one embodiment; and

FIG. 4 is a block/flow diagram showing a transmission method in accordance with one embodiment.

### DETAILED DESCRIPTION OF PREFERRED EMBODIMENTS

In accordance with the present principles, a complementary spectral coding system and method is provided for virtual I/Q multiplexing for M-ary OFDM applications. The in-phase (I) and quadrature (Q) value of the M-ary OFDM signal can be carried by separate optical codes due to the good orthogonality of the code design. This approach also provides scalable access and security add-ons for OFDM radio-over-fiber applications.

The complementary spectral coding scheme which enables virtual I/Q multiplexing for M-ary OFDM applications can support various signal modulation formats including analog waveforms of OFDM. The complementary spectral coding scheme is an incoherent approach thus the requirement on the coherence of the optical source is low. It is therefore suitable for PON applications due to its cost-effective design which may utilize off-the-shelf components.

The good orthogonality of the code design will insure minimum interference between different channels therefore the integrity of I/Q multiplexing. Moreover, since only two optical codes are used, one the I signal and one for the Q signal, more symbol alphabets can be used, such as 16-QAM, to increase the net data rate. This results in lower cost for higher data rates.

Embodiments described herein may be entirely hardware, entirely software or including both hardware and software elements. In a preferred embodiment, the present invention is implemented in a combination of hardware and software. The software may include but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

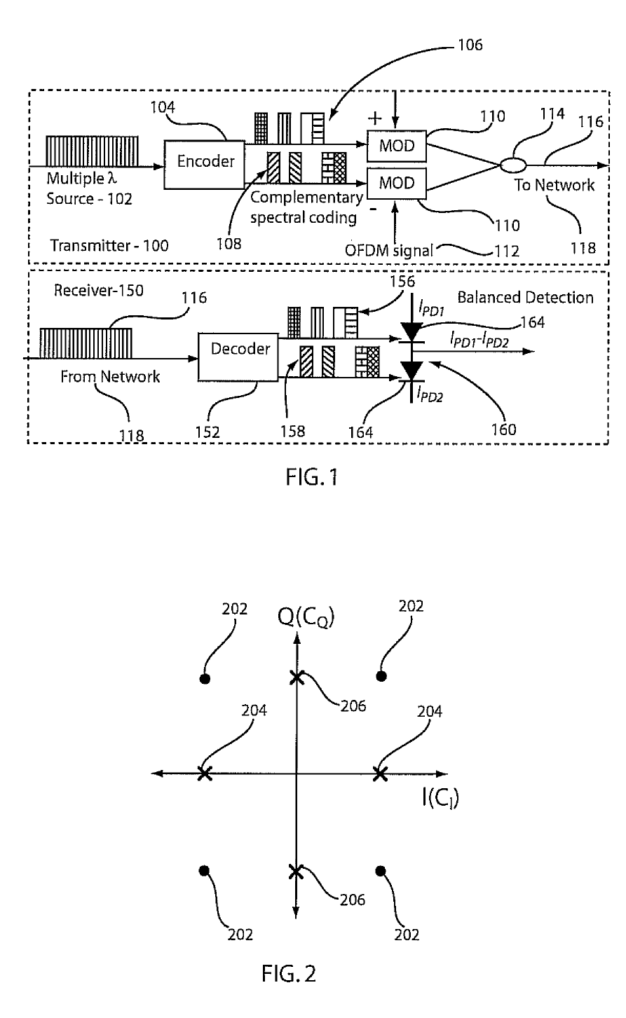

Referring now to the drawings in which like numerals represent the same or similar elements and initially to FIG. 1, a transmitter 100 and a receiver 150 are shown in accordance with one illustrative embodiment to demonstrate complementary spectral coding in accordance with the present principles. In the transmitter 100, a multiple wavelength optical source 102 such as an array of distributed feedback (DFB) lasers or a super-luminescent light emitting diodes (SLED) is employed to send a wide spectrum optical signal to an encoder 104. The source signal includes multiple wavelengths (wide spectrum) designated in FIG. 1 as bins or areas of different textures (e.g., the number of spectral bins may be, e.g., eight bins with 100 GHz of spacing for each bin). The encoder 104 separates the wide spectrum into two complementary spectral distributions 106 and 108 by an arrangement of spectral bins in the optical encoder 104.

The optical encoder 104 can be implemented by integrated wavelength division multiplexing (WDM) filter technologies such as fiber Bragg gratings (FBGS) or array waveguide gratings (AWGs) to provide complementary spectral encoding (CSE). The two spectral distributions 106 and 108 are then modulated separately in intensity with opposite polarities of the electronically generated OFDM signal 112 by modulators 110. Each CSE code has two spectral tributaries that are complementary, and the two tributaries together are viewed as one code in the design.

The OFDM signal content, which may include both real and imaginary values, will be generated by electronic digital/analog converters (DACs). The modulation refers to conversion of an electronic signal to an optically coded signal. Each CSE channel can support exactly half of the OFDM signal (either real or imaginary). Electro-optic (EO) intensity modulators such as LiNBO₃ MZI can be used.

The opposite polarity modulation is a special feature and provides that the two spectral tributaries of the CSE code will be modulated differentially. For example, if the electronic signal for EO modulation is sin(wt), then one spectral tributary will be driven with the signal (1+sin(wt)) and the other with (1−sin(wt)). (There is no negative number after EO modulation).

The modulation may include virtual IQ multiplexing, which may be performed at the same time or separately from the intensity modulation, for example, intensity modulating the complementary spectral codes with opposite polarity, and then separately modulating I/Q channels of M-ary OFDM on different complementary spectral encoded (CSE) codes.

The two modulated distributions are then combined (e.g., passively coupled) using a multiplexer 114 to form a complementary spectral encoded (CSE) signal 116. The two modulated distributions are then combined to form:

$$\hat{I} ( t ) = \frac{1}{2} \overline{P} \cdot ( 1 + S ( t ) \cdot {\hat{C}}_{1} ) \qquad ( 1 )$$

where P̅ is the average power for each individual spectral bins, assuming it is the same across the whole system; S(t) is the normalized in-phase or quadrature OFDM signal with maximum and minimum at 1 and −1; and Ĉ_{I} is the code vector for the complementary spectral coding, and the number of vector elements N is equal to the number of spectral bins used for the CSE signal. The vector elements will take the value of 1 and −1, each value representing one of the two complementary spectral distributions created by the encoder 104.

The combined modulated distributions are then sent to a network 118 by code multiplexing (114). The CSE signal is preferably sent over a fiber transmission line or PON network using code division multiple access (CDMA) technology.

At the receiver 150, the multiplexed signals (116) are first sent to a matched decoder 152 for the intended CSE OFDM signal. The number of decoders needed to decode all the multiplexed signals is the same as the number of encoders used during transmission. In the configuration of IQ multiplexing one OFDM channel, a total of two CSE encoders and two CSE decoders will be used. If there are more OFDM channels (or any other CSE signal) transmitting on the network, then more encoders and decoders may be employed. The total number of channels that a CDMA network can support depends on the total orthogonal codes, which is roughly equal to the number of spectral bins used.

The decoder 152 splits the incoming signals into two spectral distributions 156 and 158 exactly the same as in the matched encoder 104. FBGs and/or AWGs may be employed in CSE decoding. The two distributions 156 and 158, which are complements of each other, are sent to two inputs of a balanced photo detector 160. The correctly decoded CSE signal, having exact opposite polarity in the two distributions 156 and 158, can thus be recovered by balanced detection and produce the transmitted OFDM signal. The balanced detector 160 may include photodetectors (PD) 164, such as photodiodes or other light sensitive elements. The balanced photodetector 160 extracts intended signals while minimizing multi-channel interference. The CSE codes used in the network 118 are designed to be orthogonal to each other, therefore the subtracted photo-current (I_{PD1}-I_{PD2}) of other CSE signals multiplexed on the same network will be zero and in theory create no interference to an intended signal. To the CSE decoder, the intended signal is basically the signal that is encoded using the matched CSE encoder. It should be noted that any signal type may be employed.

The subtracted photo-current for the correctly decoded signal may take the following form:

$$\hat{i} ( t ) = {S}_{1} ( t ) \cdot \frac{( {\hat{C}}_{1} \cdot {\hat{C}}_{1}^{T} )}{N} = {S}_{1} ( t ) \qquad ( 2 )$$

At the same detector, the subtracted photo-current for the CSE quadrature signal will be:

$$i ( t ) = {S}_{Q} ( t ) \cdot \frac{( {\hat{C}}_{Q} \cdot {\hat{C}}_{1}^{T} )}{N} \qquad ( 3 )$$

The CSE codes used for virtual I/Q multiplexing are designed to be orthogonal to each other, therefore Ĉ_{Q}-Ĉ_{I}^{T} will be zero and to create the no interference condition for the intended signal.

Referring to FIG. 2, two CSE channels can be used to support M-ary OFDM transmission. An example of the I/Q multiplexing principle for a QPSK signal is shown where solid circles 202 represent the value of the QPSK symbols. Their values projected on the I-axis (crosses 204) will be encoded with optical code C_{I}, while another optical code C_{Q} will be used to encode the projected value on the Q-axis (crosses 206).

At the receiver side, two matched decoders will be used to distinguish the in-phase and quadrature components for each incoming CSE M-ary OFDM signal. The CSE codes used for virtual I/Q multiplexing are designed to be orthogonal to each other, therefore, create no cross interference between the in-phase signal and quadrature signal.

An optical CDMA system has at least two CSE channels used to support M-ary OFDM transmission by the method of virtual I/Q multiplexing. The CSE codes used for virtual I/Q multiplexing are designed to be orthogonal to each other; therefore, the cross interference between the in-phase signal and quadrature signal can be minimized. The receiver in the optical CDMA network can then use two matched decoders to distinguish the I/Q components for each incoming CSE M-ary OFDM signal. The receiver 150 may perform I/Q signal recombination by parallel sampling of the detected I/Q channel waveforms. Electronic Fast Fourier Transforms (FFT) are employed for OFDM signal demultiplexing with complex input values. The use of virtual I/Q multiplexing can be implemented using direct intensity modulation on CSE codes, avoiding the use of coherent detection to reduce system complexity and cost.

OFDM is a form of multi-carrier multiplexing, where the signal is divided into many sub-carriers for transmission. Each sub-carrier is modulated independently. Note, this modulation is different from the EO modulation mentioned above. For multiplexing, an Inverse Fast Fourier Transforms (IFFT) operation is performed on all the sub-carriers, and the results are serialized to generate the OFDM signal. Conversely, sub-carriers can be de-multiplexed through the process of sampling, parallelization, and FFT. These are standard processes for electronic OFDM. The present approach takes care of the issue of the complex values of IFFT results by using virtual IQ multiplexing using CSE codes. At the receiver, the real and imaginary parts of the OFDM signal are sampled and parallelized separately. Then, they are combined to generate the complex values for FFT inputs.

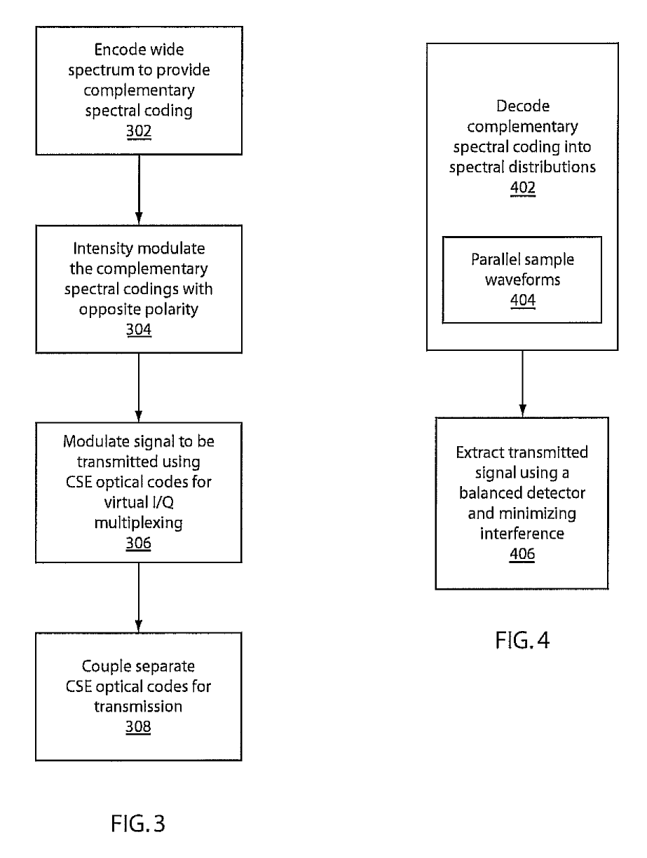

Referring to FIG. 3, a transmission method is illustrative depicted. In block 302, a wide spectrum signal, which includes a plurality of spectral bins, is encoded to provide a complementary spectral coding over at least two channels. This includes separating spectral wavelengths in a complementary way such that spectra bins appearing in a first channel do not appear in a second channel.

In block 304, the complementary spectral codings are intensity modulated with opposite polarity for each channel. In block 306, a signal to be transmitted is modulated, e.g., an M-ary Orthogonal Frequency Division Multiplexing (OFDM) signal is modulated using the complementary spectral codings of opposite polarity with separate complementary spectral encoded (CSE) optical codes to provide a virtual in-phase (I) and quadrature (Q) (I/Q) multiplexing for the OFDM signal. The complementary spectral encoded (CSE) optical codes used for virtual I/Q multiplexing are orthogonal to each other to provide a no interference condition. The two optical codes are preferably employed one for each of an I signal and a Q signal. In block 308, separate complementary spectral encoded (CSE) optical code channels are coupled for transmission on a network link.

Referring to FIG. 4, a method for receiving a complementary spectral encoded (CSE) optical coded signal is illustratively depicted. In block 402, a complementary spectral encoded (CSE) optical coded signal is decoded into two spectral distributions having opposite polarity to provide a complementary spectral coding over at least two channels. In block 404, parallel sampling of detected I/Q channel waveforms may be employed using matched decoders to decode the incoming signal from a network. The decoding includes separating spectral wavelengths in a complementary way such that spectra bins appearing in a first channel do not appear in a second channel. The complementary spectral encoded (CSE) optical codes are preferably orthogonal to each other to provide a no interference condition.

In block 406, transmitted signals, e.g., orthogonal frequency division multiplexing (OFDM) signals, are extracted from the at least two channels using a balanced photodetector while minimizing multi-channel interference due to an orthogonal relationship between CSE codes of each channel. Two optical codes are preferably employed one for each of an I signal and a Q signal.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A transmission method comprising:
encoding a wide spectrum signal, which includes a plurality of spectral bins, to provide a complementary spectral coding over at least two channels;
intensity modulating the complementary spectral codings with opposite polarity for each channel; and
modulating an M-ary Orthogonal Frequency Division Multiplexing (OFDM) signal using the complementary spectral codings of opposite polarity with separate complementary spectral encoded (CSE) optical codes to provide a virtual in-phase (I) and quadrature (Q) (I/Q) multiplexing for the OFDM signal.

2. The method as recited in claim 1, further comprising coupling separate complementary spectral encoded (CSE) optical code channels for transmission on a network link.

3. The method as recited in claim 1, wherein encoding includes separating spectral wavelengths in a complementary way such that spectra bins appearing in a first channel do not appear in a second channel.

4. The method as recited in claim 1, wherein the complementary spectral encoded (CSE) optical codes used for virtual I/Q multiplexing are orthogonal to each other to provide a no interference condition.

5. The method as recited in claim 1, wherein two optical codes are employed one for each of an I signal and a Q signal.

6. A method for receiving a complementary spectral encoded (CSE) optical coded signal, comprising:
decoding a complementary spectral encoded (CSE) optical coded signal into two spectral distributions having opposite polarity to provide a complementary spectral coding over at least two channels; and
extracting orthogonal frequency division multiplexing (OFDM) signals from the at least two channels using a balanced photodetector while minimizing multi-channel interference due to an orthogonal relationship between CSE codes of each channel.

7. The method as recited in claim 6, further comprising parallel sampling detected I/Q channel waveforms.

8. The method as recited in claim 6, wherein decoding includes separating spectral wavelengths in a complementary way such that spectra bins appearing in a first channel do not appear in a second channel.

9. The method as recited in claim 6, wherein the complementary spectral encoded (CSE) optical codes are orthogonal to each other to provide a no interference condition.

10. The method as recited in claim 6, wherein two optical codes are employed one for each of an I signal and a Q signal.

11. A transmitter comprising:
an encoder configured to encode a plurality of spectral bins, to provide a complementary spectral coding over at least two channels; and
an intensity modulator configured to modulate the complementary spectral codings with opposite polarity for each channel, and modulate an M-ary Orthogonal Frequency Division Multiplexing (OFDM) signal using the complementary spectral codings of opposite polarity with separate complementary spectral encoded (CSE) optical codes to provide a virtual in-phase (I) and quadrature (Q) (I/Q) multiplexing for the OFDM signal.

12. The transmitter as recited in claim 11, wherein separate complementary spectral encoded (CSE) optical code channels are coupled for transmission on a network link.

13. The transmitter as recited in claim 11, wherein the encoder separates spectral wavelengths in a complementary way such that spectra bins appearing in a first channel do not appear in a second channel.

14. The transmitter as recited in claim 11, wherein the complementary spectral encoded (CSE) optical codes used for virtual I/Q multiplexing are orthogonal to each other to provide a no interference condition.

15. The transmitter as recited in claim 11, wherein two optical codes are employed one for each of an I signal and a Q signal.

16. A receiver, comprising:
a decoder configured to decode a complementary spectral encoded (CSE) optical coded signal into two spectral distributions having opposite polarity; and
a balanced photodetector configured to extract orthogonal frequency division multiplexing (OFDM) signals while minimizing multi-channel interference due to an orthogonal relationship between CSE codes of each channel.

17. The receiver as recited in claim 16, further comprising a parallel sampler for sampling detected I/Q channel waveforms.

18. The receiver as recited in claim 16, wherein the decoder separates spectral wavelengths in a complementary way such that spectra bins appearing in a first channel do not appear in a second channel.

19. The receiver as recited in claim 16, wherein the complementary spectral encoded (CSE) optical codes are orthogonal to each other to provide a no interference condition.

20. The receiver as recited in claim 16, wherein two optical codes are employed for one each of an I signal and a Q signal.

21. The receiver as recited in claim 16, wherein the decoder includes two matched decoder one matched decoder for decoding an I signal and one matched decoder for decoding a Q signal.
